(19) United States
(12) Patent Application Publication
(10) Pub. No.: US 2010/0181354 A1
(43) Pub. Date: Jul. 22, 2010

(54) Weight-Measuring Device

(76) Inventor: Shlomo Laniado, Tel-aviv (IL)

Correspondence Address: THE NATH LAW GROUP, 112 South West Street, Alexandria, VA, 22314, US

(21) Appl. No.: 11/991,842

(22) PCT Filed: Sep. 14, 2006
(86) PCT No.: PCT/IL2006/001076

§ 371 Date: Mar. 12, 2008

Related U.S. Application Data
(63) Continuation-in-part of application No. 11/226,438, filed on Sep. 15, 2005, now abandoned.

(51) Int. Cl. A45F 3/04; G01G 19/58

(52) U.S. Cl. 224/259; 177/245

(57) ABSTRACT

A weight-measuring device is described that is adapted to be attached between two objects, and to be brought to a stretched state and to an unstretched state. The device may be attachable to a harness of the type which comprises a pair of shoulder strap assemblies, for example of the type used with backpacks, parachute units or similar constructed systems for holding or carrying an object or load to a person's body. The weight-measuring device comprises a force resistance element altered by the application of force thereto, and a weight indicator providing an indication of the force magnitude applied thereto.

### FIELD OF THE INVENTION

This invention relates to a weight/load measuring device, and more particularly, to a weight/load measuring device that is adapted to be attached between two objects to measure the force magnitude therebetween.

### BACKGROUND OF THE INVENTION

A backpack, also known by the names “book bag”, “knapsack”, “rucksack”, “haversack”, “duffle bag”, “flying bag”, is a type of bag that comprise a harness portion and a bag portion, and is a popular and effective way to carry medium to heavy loads while walking. Backpacks were originally developed for use by the military and hikers and have, over time, become a ubiquitous load carrying device. However, while backpacks are generally considered a good load carrying devices due to the fact that they distribute weight across some of the body's largest muscles, use thereof can lead to physiological and anatomical problems, especially in cases where exceedingly large loads are carried by school children.

Hereinafter in the specification and drawings all different types of bags are collectively referred to as ‘backpacks’.

Medical authorities have set forth certain guidelines and recommendations to demonstrate that improper use and wearing of backpacks can lead to muscle imbalance that can result in chronic back and neck problems. A distinctly important guideline is that suspending too much weight from the shoulders over an extended period has been shown to be detrimental to the back, causing problems ranging from simple discomfort and fatigue to spinal compression, back pain and misalignment of the spine, ailments which could persist into adulthood.

The problem has been aggravated in recent years, as young children have been carrying overweight backpacks. In particular, both the American Academy of Orthopedic surgeons (AAOS) and the Consumer Product Safety Commission (CPSC) warn that increasing numbers of children are suffering injuries to their backs and shoulders from improper utilization of their backpacks. Many experts recommend that a child carry no more than 15% of their body weight in a backpack to avoid increased risk of musculoskeletal injury. Children from grade school through high school are currently carrying far in excess of this amount. Excessive weight of a backpack may cause functional scoliosis or curvature of a healthy spine at any age. It is emphasized that even adults should not carry more than 25 kg in a backpack.

The best way to prevent danger from overloaded backpacks is to directly determine if a particular load, in backpack being carried, is too heavy for the individual carrying it. While placing the backpack on traditional scales would be suitable for determining the weight of a backpack, scales are not always available to weigh a backpack to ensure that it is not overloaded.

This problem is addressed at U.S. Pat. Application Publication No. 2005/0051586 to Siwak et al. describing a weight determining mechanism and a method for determining the weight of a piece of loaded luggage, particularly a backpack. The mechanism is generally incorporated into a carry handle of the piece of luggage allowing for it to be integral with the luggage and allowing for it to not take up additional space while allowing for quick and easy weight determinations without need for an external scale.

In addition to the dangers caused by excessive backpack weight, health care professionals advise that the total load should be equally divided between the two shoulder straps to avoid orthopedic injuries associated with shifting of excessive weight to a particular right or left shoulder. It is difficult to conclude about the optimal configuration of a backpack and a harness if the carrier is unaware of the importance of weight distribution between the two shoulders. Asymmetric weight distribution induces the carrier to avoid standing in a proper upright position and thus can lead to spinal injuries, muscle strain or similar problems. In addition, overloading the wearer's shoulders can also cause local injuries, such as strain of the trapezias muscle, pinching of nerve roots near the spine, etc.

Maintaining a natural posture, a person experiences a significant difference between side-to-side, and front-to-back upright stability. It is essential that a natural posture be preserved as closely as possible when carrying a backpack. For side-to-side stability the bag should be symmetrical and evenly loaded on each side. Symmetric loading is of particular importance, since, when most of the pack's weight is carried by slinging it on a single shoulder, it results in encouraging the wearer to bend sideways. Such abnormal posture is even more exaggerated when carrying a heavy backpack. To preserve the body side-to-side stability one has to consider first that there is no significant extra weight applied to one shoulder compared with the other. Imbalanced load hurts the shoulders while compressing on the shoulder and in time may also lead to circulatory or nerve disturbances.

There are numerous known systems for backpacks which attempt to stabilize the load, increase comfort and enhance convenience to the carrier. For example, U.S. Pat. No. 4,217,998 to Alexander describes a device comprising a set of two elongated tubes, disposed in telescoping relation to each other with a spring-loaded push button carried by the inner tube adjustably releasably locking the tubes together so that they can have various desired combined lengths. One of the tubes has a slip resistant backpack shoulder strap connector attached at its front end and the other of the tubes has a backpack rear frame connector pivotally secured to its rear end. The improved backpack utilizes a pair of the described novel devices, connected to opposite sides of the backpack rear frame and projecting forwardly to engage the two backpack shoulder straps. Thus, the two devices are disposed on opposite sides of the backpacker. Their purpose is to shift the center of gravity and balance of the backpack from aft of the vertical midline of the backpacker when standing erect with the backpack in place, that is, from a very uncomfortable and clumsy position to a more forward comfortable position adjacent that vertical midline of the backpacker, without the backpacker having to continually tug at the backpack shoulder straps and hunch over to achieve the weight shift.

U.S. Patent Application Publication No. 2004/0065708 to Amram discloses backpack that has straps which may be repositioned, removed and replaced is designed to reduce muscle strain when the bag is carried by improving the balance of the load. Re-positioning the straps can enable a person to reposition the load closer to the center of the body to reduce the leverage exerted by an unbalanced load. An additional feature is that removable straps can be interchanged or replaced inexpensively with other straps that have different colors, trademarks, advertisements, or other indicia of support or affiliation.

International Patent Publication No. WO 2004/100706 to Manoni describes a balanced backpack of the type comprising bag containers supported on the shoulders of a user by shoulder straps, allowing an appropriate weight distribution, with a front-rear balance as well as a side balance, and comprising: a rear bag container associable to a bust by means of a pair of shoulder straps, said rear bag container being located symmetrically with respect to said shoulder straps; a fastening point associated to said shoulder straps and located frontally to the bust in a symmetrical position; a front bag container fastenable to said fastening point, so as to charge the associated load thereon, wherein the weight loadable in each bag container with regard to the volume of the bag containers has a rear/front ratio ranging from 2.0 to 0.8.

### SUMMARY OF TILE INVENTION

The present invention relates to a weight/load measuring device that is adapted to be attached between two objects to measure the forces therebetween.

In accordance with one aspect of the present invention, there is provided a weight/load measuring device that is adapted to be attached between two objects to measure the force magnitude therebetween, which comprises a force resistance element altered by the application of force thereto, and a weight indicator providing an indication of the force magnitude applied thereto; the device being adapted to be brought to a stretched state and to a unstretched state, so that when the weight-measuring device is in the stretched state the force resistance element is altered by the application of forces by the two objects, and when the weight-measuring device is in the unstretched state the force resistance element is not altered by the application of forces by the two objects, the unstretched state thereby improving the calibration lifespan of the force resistance element. There being indicia provided for the state of stretching of weight indicator corresponding with the weight applied thereto.

The calibration lifespan of the weight-measuring device is improved by reducing the time the force resistance element is altered.

Multiple weight-measuring devices may be attached to multiple objects to determine asymmetric load between the objects. For example, there may be provided a backpack fitted with two shoulder straps, each fitted with a weight-measuring device according to the invention. In the event that the measuring device indicates an asymmetric load, a user may wish to correct the imbalance. Thus, the weight-measuring device may further comprising a balancing mechanism which is adapted to change the force magnitude between the two objects to which it is attached between. The balancing mechanism may be adapted to lengthen and/or shorten the distance between the two objects, thereby changing the force magnitude therebetween. The balancing mechanism may be an integral part of the weight-measuring device.

The force resistance element may be a strap which is made of an elastic material. The elastic material may be made of natural rubber, however, any suitable material may be used.

The weight indicator may comprise a numerical scale associated with said force resistance element, or other indication means such as a colored scale, a scale provided with geometrical illustrations, etc.

The weight measuring device may further comprise a display window for viewing the weight indicator. The display window may be fitted with a magnifying glass for improving visualizing of the scale.

The two objects between which the weight-measuring device is attached may be two portions of a shoulder strap assembly of a harness. The harness may be part of a backpack or a parachute apparatus, etc.

According to a further aspect of the present invention, there is provided a harness comprising a pair of shoulder strap assemblies, with each shoulder strap assembly including a weight-measuring device according to the present invention, including any one or other of the features described above.

The harness may enable a user to quickly and easily provide a balance control of the shoulder strap assemblies by operation of the weight-measuring device for determining the weight load carried by each shoulder along with the total weight carried by the user and adjusting it as needed.

If the harness is part of a backpack, and is secured to a user who is wearing it, the weight of the backpack carried by the user can be measured by activating both weight-measuring devices simultaneously, giving the approximate total weight of the backpack carried by the user. Additionally, activation of only one of the weight-measuring devices may display the weight carried by the corresponding shoulder strap assembly. A particular advantage of this aspect is the potential to provide easy parent awareness of the load and balance thereof caused on a child carrying such a backpack. Thereby, allowing the parent to prevent problems caused by excessive load, asymmetric strap configuration and/or inter-shoulder weight imbalance.

The balancing correction can also be made by readjusting the straps in the harness via fasteners in the shoulder strap assemblies and/or by rearranging the bag's contents (i.e. shifting heavy objects from side to side).

According to any of the above aspects, the weight-measuring device may also be adapted to be detachably to the objects to which it is attached, or it may be designed to be permanently attached to the two objects.

There has thus been outlined, rather broadly, the more important features of the invention so that the detailed description thereof that follows hereinafter may be better understood, and the present contribution to the art may be better appreciated. Additional details and advantages of the invention will be set forth in the detailed description.

The invention calls for a force measuring device for connecting force exerting points and for measuring a force therebetween, the force measuring device including a force measuring mechanism designed such that an accuracy of the mechanism in measuring a force is not diminished by the force exerting points over time.

According to one of its aspects, the invention is directed to a force measuring device for connecting between force exerting points and for measuring a force therebetween, the force measuring device including a force adjustment mechanism designed for incrementally adjusting a distance between the force exerting points.

The prior art provides several examples of load measuring/balancing devices. Although some of these devices can be used to measure and/or adjust load distribution in backpacks, such designs suffer from several inherent limitations. Prior art load measuring devices employ load measuring mechanism which also function in load bearing and as such, these mechanisms display a loss in measuring quality over time due to plastic rather than elastic stretching and the like.

In addition, prior art devices which enable load adjusting typically use buckles and straps which cannot be adjusted via precise and incremental adjustment actions which can be accurately repeated. This limitation is particularly problematic in the case of backpacks in which precise adjustment of two straps is required for proper load adjustment.

While reducing the present invention to practice and having the specific goal of traversing these limitations of prior art designs, the present inventors have designed a load measuring and adjustment device which includes an accurate load measuring mechanism which does not diminish in measurement quality over time and a load distribution mechanism which is incremental, repeatable and precise.

The device according to the present invention is suitable also as a ‘stand alone’ article, namely suitable for separate accessory article detachably connectable to any device.

### BRIEF DESCRIPTION OF THE DRAWINGS

In order to understand the invention and to see how it may be carried out in practice, several embodiments will now be described, by way of non-limiting examples only, with reference to the accompanying drawings, in which:

FIG. 1A is a perspective view of a weight-measuring device according to a first embodiment of the present invention;

FIG. 1B is a perspective view of the weighing strap of the weight-measuring device illustrated in FIG. 1A;

FIG. 1C is a side view of the weighing strap illustrated in FIG. 1B;

FIG. 1D is a perspective view of a portion of the weighing strap illustrated in FIGS. 1B and 1C attached to a first strap;

FIG. 1E is a perspective view of the weight-measuring device illustrated in FIG. 1A, attached between a first strap and a second strap, e.g. of a backpack;

FIG. 1F is a schematic isometric cross-sectional view of the weight-measuring device illustrated in FIG. 1E;

FIG. 1G is a schematic side cross-sectional view of the weight-measuring device illustrated in FIG. 1E;

FIG. 1H is an enlarged view of the portion marked G in FIG. 1G;

FIG. 1I is the same as FIG. 1H, with a button in the housing being depressed;

FIG. 1J is a weight-measuring device of the type illustrated in FIGS. 1A-1I, detachably/attachably articulated to a backpack;

FIG. 1K is a weight-measuring device of the type illustrated in FIGS. 1A-1I, attached to a backpack;

FIG. 2A is a perspective view of a further embodiment of a weight-measuring device according to the present invention, including an integral balance mechanism;

FIG. 2B is a top exploded view of the balance mechanism of the weight-measuring device illustrated in FIG. 2A;

FIG. 2C is a bottom exploded view of the balance mechanism illustrated in FIG. 2B;

FIG. 2D is an assembly view of the balance mechanism illustrated in FIGS. 2B and 2C;

FIG. 2E is a schematic isometric cross-sectional view of the weight-measuring device illustrated in FIG. 2A;

FIG. 2F is an enlarged view of a portion of the weight-measuring device illustrated in FIGS. 2A and 2E;

FIG. 2G is a schematic sectioned side view of the weight-measuring device illustrated in FIGS. 2A and 2E-2F;

FIG. 2H is an enlarged schematic side view of the weight-measuring device illustrated in FIGS. 2A and 2E-2G;

FIG. 2I is a bottom view of the weight-measuring device illustrated in FIGS. 2A and 2E-2H;

FIG. 3A is a perspective view of a further example of a weight measuring device of the present invention, including an integral balance mechanism;

FIG. 3B is an exploded view of the weight measuring device illustrated in FIG. 3A, excluding the straps;

FIG. 3C is an isometric cross-sectional view of the weight measuring device illustrated in FIG. 3A excluding the lower strap;

FIG. 3D is a plan view of the bottom housing component shown in FIGS. 3A-3C;

FIG. 3E is an isometric view of the bottom housing component illustrated in FIG. 3D;

FIG. 3F is an alternate isometric view of the bottom housing component illustrated in FIG. 3D;

FIG. 3G is an isometric view of the weight measuring device illustrated in FIG. 3B, excluding the top and bottom housing element, with the elastic strap in an unstretched position;

FIG. 3H is an isometric view of the weight measuring device illustrated in FIG. 3G, with the elastic strap in a stretched position;

FIG. 3I is an inner side view of a portion of the weight-measuring device illustrated in FIG. 3A;

FIG. 3J is an enlarged isometric view of a portion of the balance mechanism illustrated in FIGS. 3A-3C, 3G and 3H, when the lever is not activated;

FIG. 3K is an enlarged isometric view of a portion of the balance mechanism illustrated in FIG. 3J, when the lever is activated;

FIG. 3L is a plan view of the device shown in FIG. 3A, excluding the top housing component and upper and lower straps, when the strap lengthening button is not activated; and

FIG. 3M shows a plan view of the device shown in FIG. 3L, when the strap lengthening button is activated.

### DETAILED DESCRIPTION OF EMBODIMENTS

The principles and operation of a backpack according to the present invention may be better understood with reference to the accompanying description and the drawings, in which embodiments of the invention are illustrated. It should be understood that these drawings are given for illustrative purposes only and are not meant to be limiting. The present invention may be embodied in many different forms and should not be constructed as limited to the embodiments set forth herein. The same reference numerals and alphabetic characters will be utilized for identifying those components which are common in the backpack and its components shown in the drawings throughout the present description of the invention.

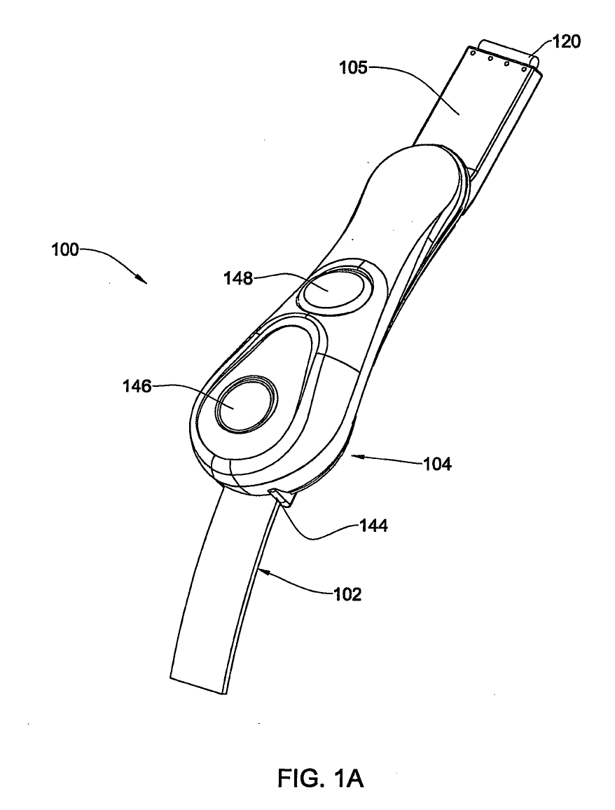

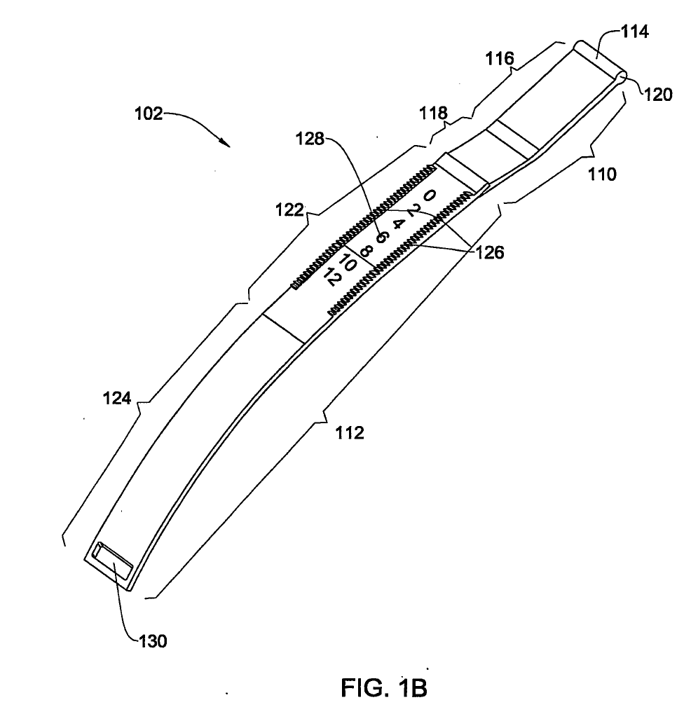

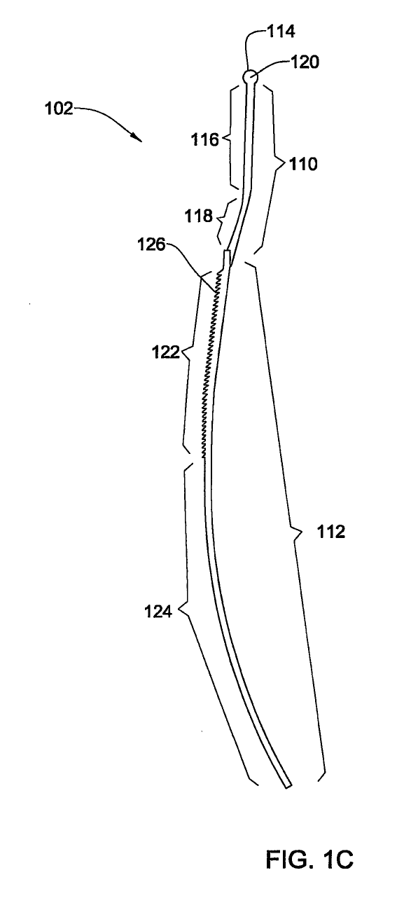

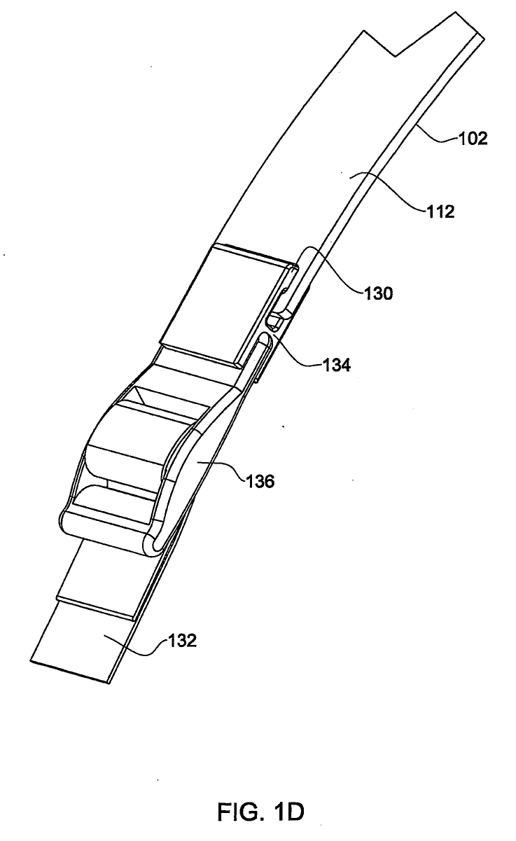

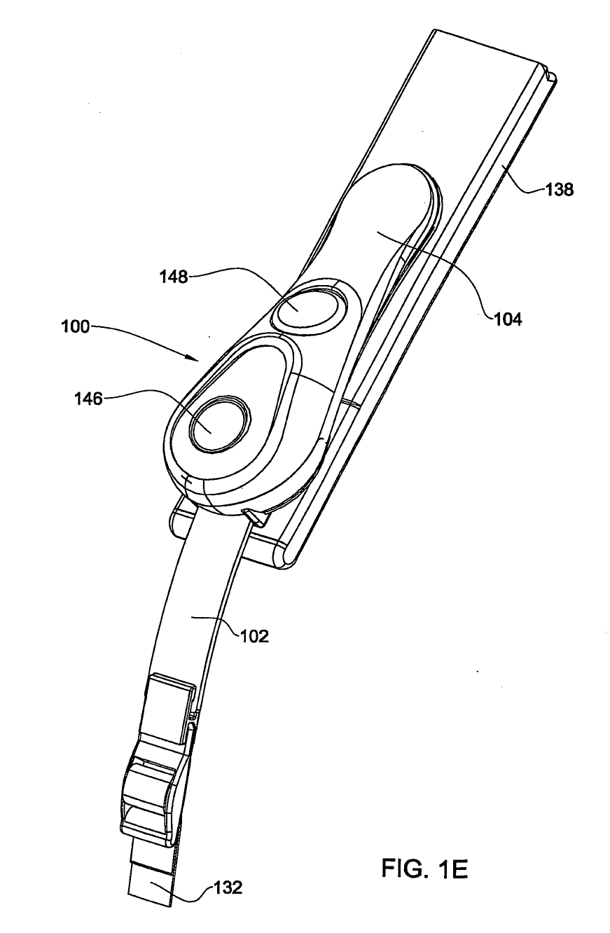

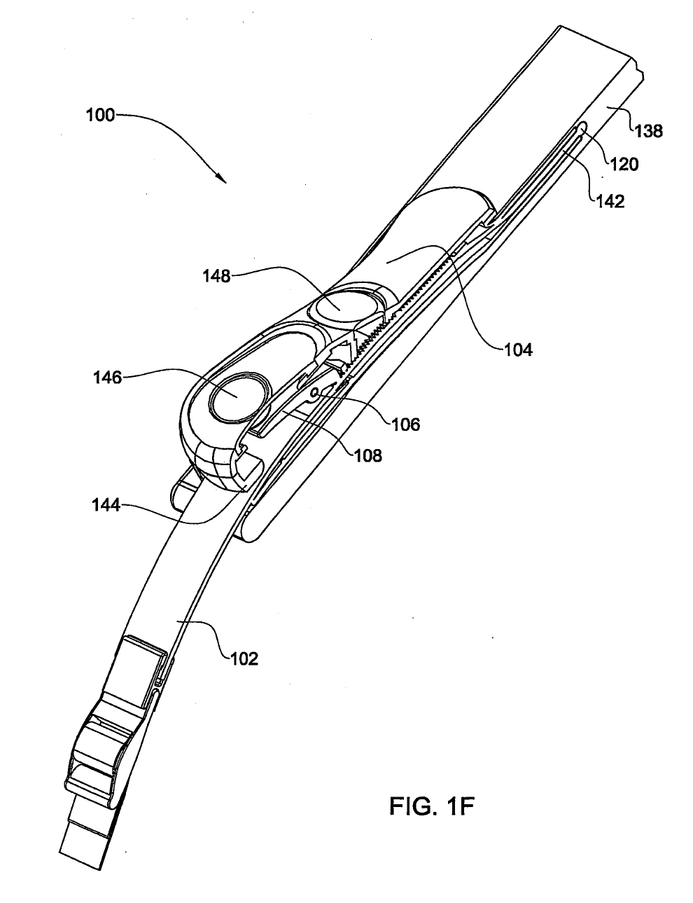

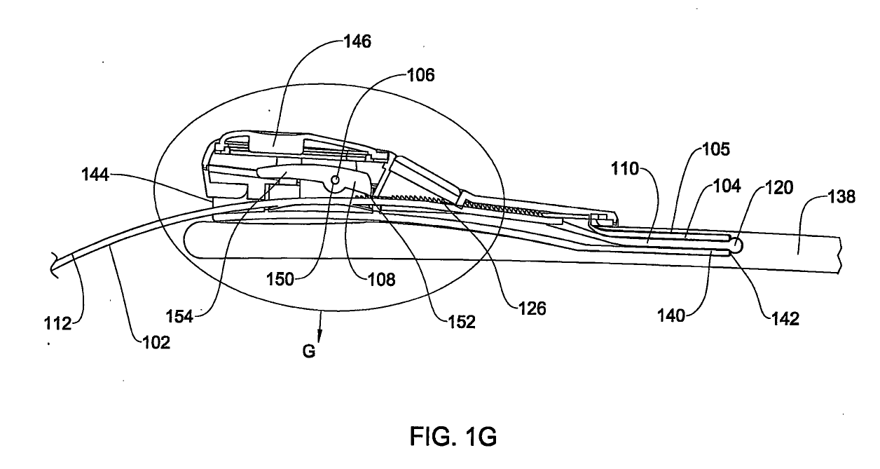

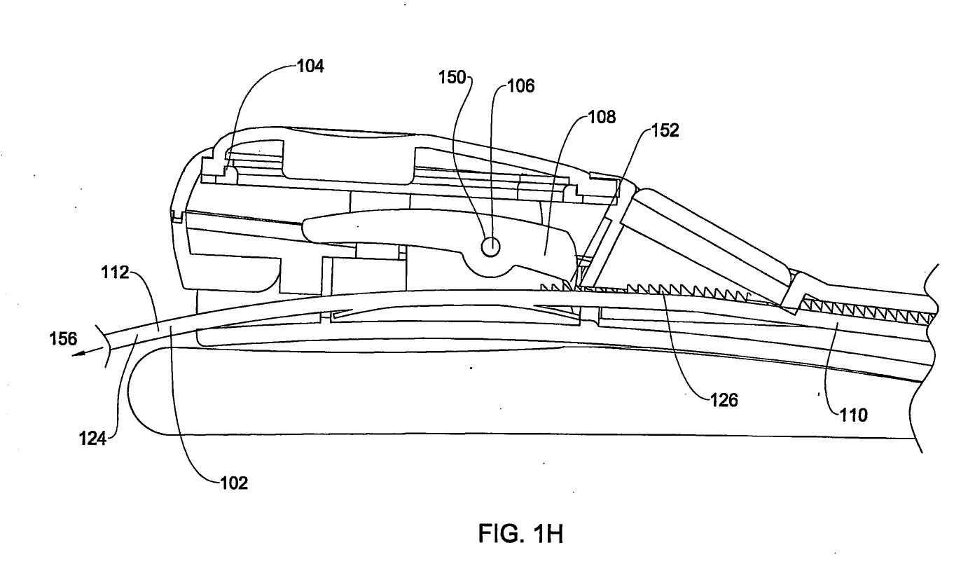

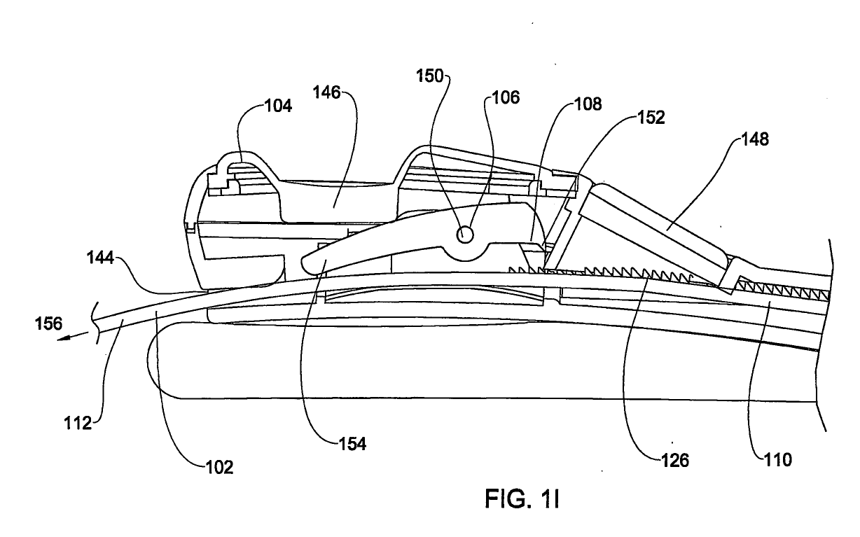

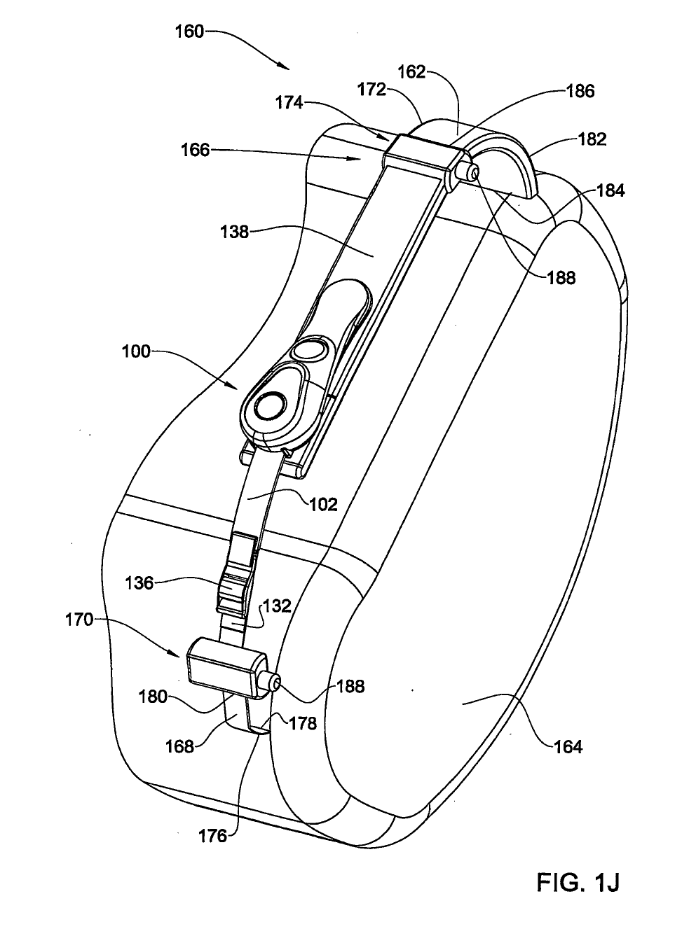

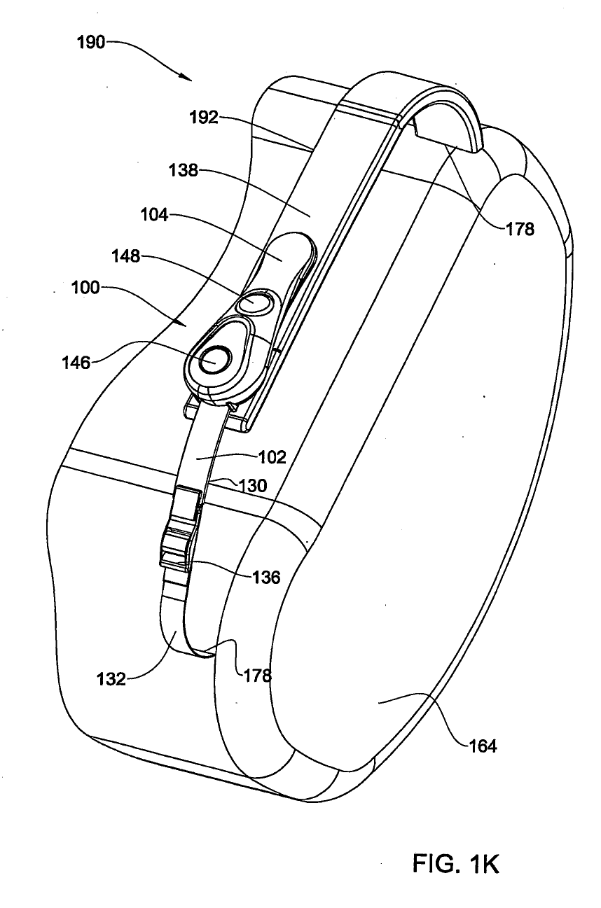

Referring now to FIG. 1A, a first embodiment of a weight-measuring device 100 is illustrated. The weight measuring device 100 comprises a weighing strap 102, a housing 104 through which the weighing strap 102 is slotted, a pin 106 (FIG. 1F) mounted inside the housing 104 and a pawl 108 (FIG. 1F) pivotably mounted on the pin 106 and normally biased in a clockwise direction.

Turning attention now to FIGS. 1B-1C, the weighing strap 102 comprises a force resistance element 110 in the form of an elastic portion made of natural rubber, and a plastic portion 112, integrated through a manufacturing process or articulated thereafter. While any suitable material with elastic properties may be used for the elastic portion, during research conducted for the current invention natural rubber was shown to have advantageous qualities over other elastic materials tested. Similarly, the plastic portion need not necessarily be made of plastic, but rather must be made from a material which does not have elastic properties and does not deform under the load that the weight-measuring device 100 is expected to be subjected to.

The elastic portion 110 comprises a top end 114, an intermediate portion 116 and a bottom end 118. The top end 114 comprises an bulging portion 120 which, referring briefly to FIG. 1A, when the weight measuring device 100 is assembled and consequently the weighing strap 102 is inserted through the housing 104, is anchored to the outside of the housing 104, and is thicker than the slot 142 (FIGS. 1F and 1G) in the housing 104 to which it is adjacent. Reverting to FIGS. 1B and 1C, the intermediate portion 116 is thinner than the bulging portion 120, and when the elastic portion 110 is inserted through the housing 104, the intermediate portion 116 slides easily through the first slot 142 (FIGS. 1F and 1G) to which the bulging portion 120 is anchored, for reasons which will become apparent hereinafter.

The plastic portion 112 comprises a top-half section 122 integrally formed with the bottom end 118 of the elastic portion 110, and a bottom-half section 124. The top-half section 122 comprises two narrow columns 126 of uni-directional slanted teeth disposed along the edges thereof and a weight indicator in the form of a series of ascending numbers 128, for indication of weight measurement, between the teeth 126. In this respect the numbers 128 on the elastic portion 110 are distanced in a calculated manner, proportionately to the magnitude of force required to stretch the elastic portion 110 alternatively, instead of numbers there may be other indications such as drawings, colors, etc. The bottom-half section 122 comprises a coupling slit 130 in the form of a rectangular slit.

Turning attention additionally to FIG. 1D, the coupling slit 130 in this example, is used to allow connection of the weight-measuring device 100 to a first strap 132 of a harness (not shown) via a buckle 134 and a balancing mechanism in the form of a strap fastener 136. It should be noted that the coupling element 130 may be used to attach it to the object to be measured via any standard connection components.

Referring now to FIGS. 1E-1G, the weight-measuring device 100 is shown connected between a first strap 132 (which in the context of a harness of a backpack could be referred to as a ‘bottom strap’) and a second strap 138 (which in the context of a harness of a backpack could be referred to as a ‘top strap’). The second strap 138 comprises a cavity 140, within which a sleeve-like portion 105 of the housing 104 is inserted. The second strap 138 is attached, e.g. by sewing, around the sleeve-like portion 105 of the housing 104 within the cavity 140, to secure the position of the housing 104 therein.

The housing portion 104 comprises a first slot 142, a second slot 144, a depressible button 146 and a display window 148. As mentioned above the weighing strap 102 is slotted through the housing 104, this is accomplished via the first slot 142 and the second slot 144. In FIG. 1G the elastic portion 110 of the weighing strap 102 is clearly shown to be slotted through both the first slot 142 and anchored thereto by the bulging portion 120, while the plastic portion 112 is capable of sliding motion through the second slot 144. The display window 148 is positioned above at least one of the series of numbers 128 and is made of magnifying glass to facilitate easy viewing thereof.

The pawl 108 comprises a pivot hole 150 adapted for the insertion of the pin 106, a pointed distal projection 152 adapted for engagement to the teeth of the narrow columns of uni-directional slanted teeth 126 on the plastic portion 112, and a button portion 154 disposed at the end of the pawl 108 underneath the button 146 of the housing portion 104.

A pin 106 is mounted inside the housing 104 to support the pawl 108 pivotably mounted thereon.

Operation of the Weight-Measuring Device:

Referring first to FIG. 1E, in operation the weight-measuring device 100 is necessarily attached between two objects. As mentioned above, in this embodiment the weight-measuring device 100 is connected between a first strap 132 and a second strap 138.

Referring now to FIG. 1H, the pawl 108 is shown in it's normally biased position, with the distal projection 152 engaging the teeth 126. In this position, stretching of the weighing strap 102, created, for example, by a force exerted on the bottom-half section 124 of the plastic portion 112 by the first strap 132 in the direction of the arrow numbered 156, or by the second strap 138 on the housing 104 in the direction opposite to arrow 156, is arrested by the above-mentioned engagement of the distal projection 152 with the teeth 126. To elaborate, stretching of the weighing strap 102 does not occur as the plastic portion 112 is not elastic, therefore it also does not stretch to any significant amount, and the elastic portion 110 is anchored at one end to the housing 104 and the other end to the above-mentioned engagement between the distal projection 152 and the teeth 126.

However, it should be noted that if the elastic portion 110 was in tension before the engagement between the distal projection 152 and the teeth 126, the uni-directional nature of the teeth 126 allows the weighing strap 102 to contract, i.e. at least a portion of the elastic portion 110 and the plastic portion 112 will move in the direction opposite to the arrow numbered 156, towards the anchored bulging portion 120. Thus, the elastic properties of the elastic portion 110 will contract the weighing strap 102 until the elastic portion 110 is no longer stretched, thereby constituting an “unstretched mode” of the weight-measuring device 100.

Referring now to FIG. 1I, the pawl 108 is shown in a rotated position resulting from the depression of the depressible button 146, counter to the normally biasing force, by a user of the weight-measuring device 100. The depressible button 146 moves the button portion 154 disposed at the end of the pawl 108 in the direction of the weighing strap 102. In this position, the distal projection 152 disengages the teeth 126, allowing stretching of the elastic portion 110 of the weighing strap 102, if there are forces exerted on the bottom-half section 124 of the plastic portion 112 by the first strap 132 in the direction of the arrow numbered 156, or by the second strap 138 on the housing 104 in the direction opposite to arrow 156.

During stretching, the plastic portion 112, which is not elastic, does not stretch to any significant amount, however, the elastic properties of the elastic portion 110 allow stretching thereof. This stretching will allow a different portion of the elastic portion 110, comprising at least one of the numbers 128, to be disposed beneath the display window 148. A user may then view the numbers 128 via the magnifying glass 148 and hence, knowing the relationship between the numerical value shown and the magnitude of stretching force required to view such number, estimate the magnitude of force and/or weight stretching the weight-measuring device 100. This measuring position, thereby constitutes the “stretched mode” of the weight-measuring device 100.

The user then releases the depressible button 146, which allows the pawl 108 to pivot back to its normal position and the distal projection 152 to re-engage the teeth 126, returning the weight-measuring device 100 to the unstretched position. It should be noted that the unstretched position improves the calibration lifespan of the force resistance element/weighing strap 102 as it reduces the amount of time that the elastic portion 110 is stretched. Such stretching only occurring during measurement of the magnitude of force applied to the weight-measuring device 100.

In any case, the weight scale calibration can be checked and corrected. This may be suggested following long use, when the stretchable element may become slightly lax and overly extended to show false reading. A proper calibration can, for example, be performed while comparing indications of the weight-measuring device 100 against a known amount of weight attached to the first or second strap. Then, the numbers 128 may be corrected to reflect the weight shown. Thus, the weight-measuring device 100 will resume accuracy.

Turning attention now to FIG. 1J, there is illustrated an example of the weight-measuring device 100 being detachably attached to an object in the form of a backpack 160 comprising a harness 162 configured for securing the backpack 160 on a user.

The harness 162 comprises two shoulder strap assemblies 166 (only one of which can be seen in the partial view shown). Each shoulder strap assembly 166 comprises a lower strap 168, a first strap 132, a lower fastener 170, a weight-measuring device 100, a second strap 138, an upper strap 172 and an upper fastener 174. The lower strap 168 extends between two ends, a first end 176 which is attached (e.g. by sewing or otherwise) to a lower portion 178 of a bag portion 164 and a second end 180 engaging the first strap 132 via the lower fastener 170.

As described in previous figures the weight measuring device 100 is attached between the first strap 132 and second strap 138. The upper strap 172 extends between two ends, a first end 182 which is attached (e.g. by sowing or otherwise) to an upper portion 184 of the bag portion 164 and a second end 186 engaging the second strap 138 via the upper fastener 174. The lower fastener 170 and the upper fastener 174 both comprise a pin 188, the arrangement of which facilitates, upon removal of the pin 188, disengagement of the straps connected via the respective fastener. However, it should be noted that any fastener or similar type device which allows the engagement and disengagement of the straps is suitable for this purpose.

When the backpack 160 is carried or worn by a user, the weight load applied to the each of the strap assemblies 166 can be measured or estimated by the user via operation of the weight-measuring device 100 as described above. It should be noted that force applied to the weight-measuring devices 100 on each of the shoulder strap assemblies 166 may be measured separately or simultaneously, allowing the option to measure the load carried by each shoulder strap assembly. Additionally the load of each strap assembly and hence the amount of force measured by the weight-measuring devices 100 may be balanced through lengthening or shortening the first straps 132 via the strap fasteners 136. In this example, the weight-measuring device can be attachably detached from the backpack 160 via the lower fastener 170 and upper fastener 174. This may be done, for example, when the backpack is put in the laundry.

Turning attention now to 1K, the weight-measuring device 100 may, alternatively, be fixedly attached to a harness 190 having a shoulder strap assembly 192 only comprising the elements shown in FIG. 1E. In such case the first strap 132 extends between a lower portion 178 of the bag portion 164 and the coupling slit 130 of the weighing strap 102, and the second strap 138 extends between an upper portion 178 of the bag portion 164 and is attached to the housing 104 as described above.

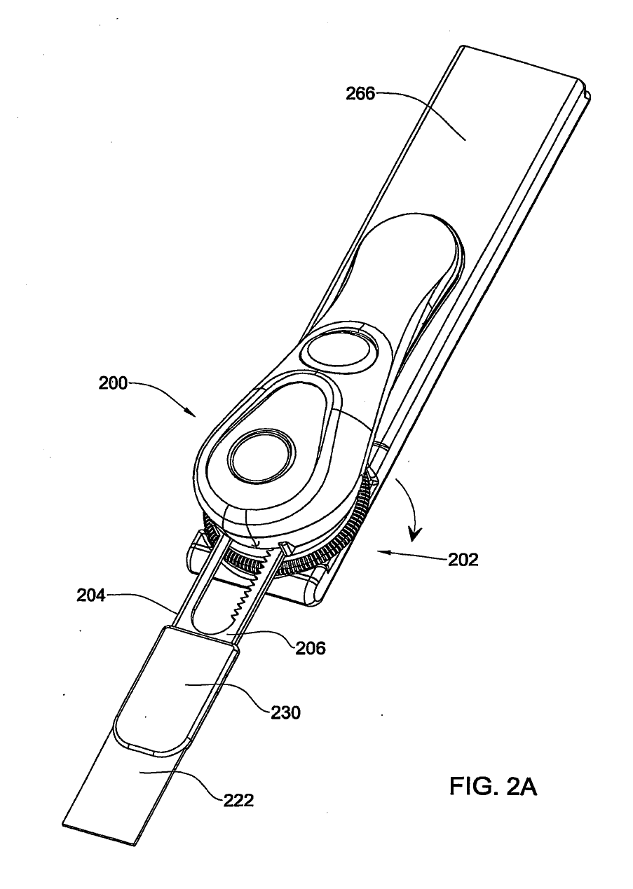

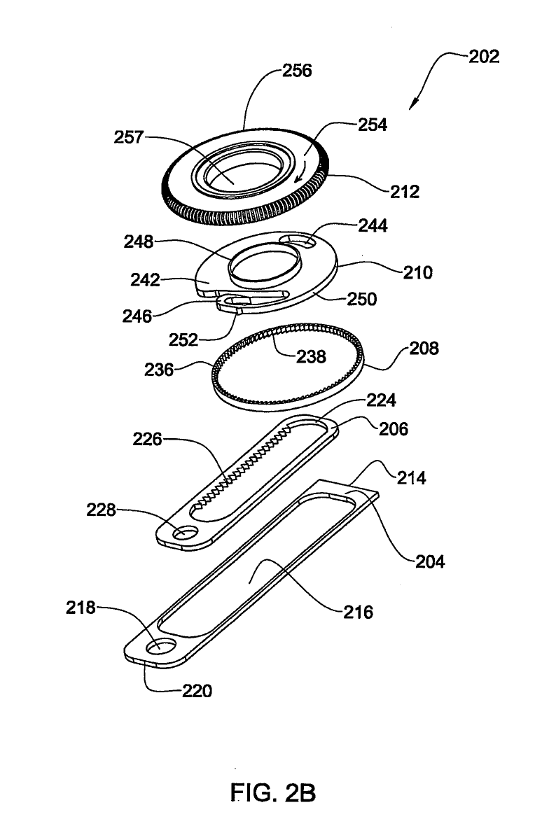

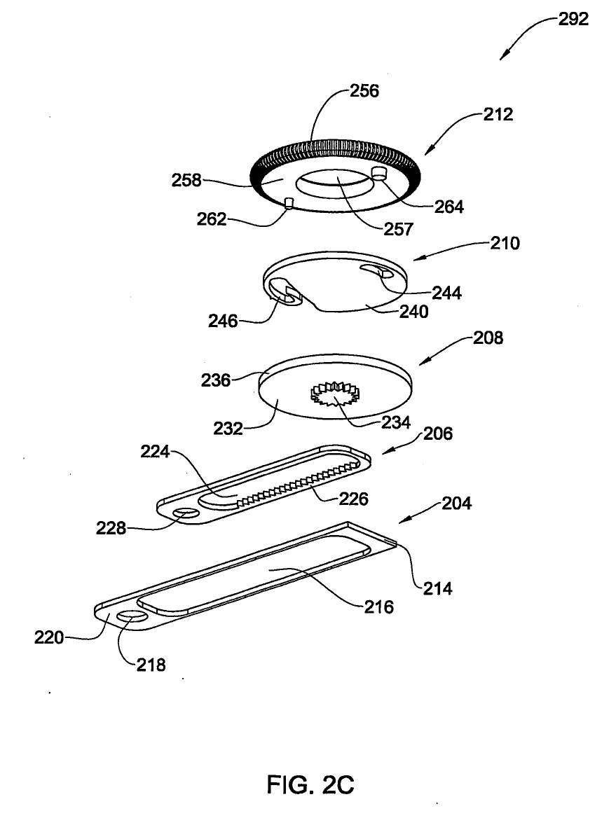

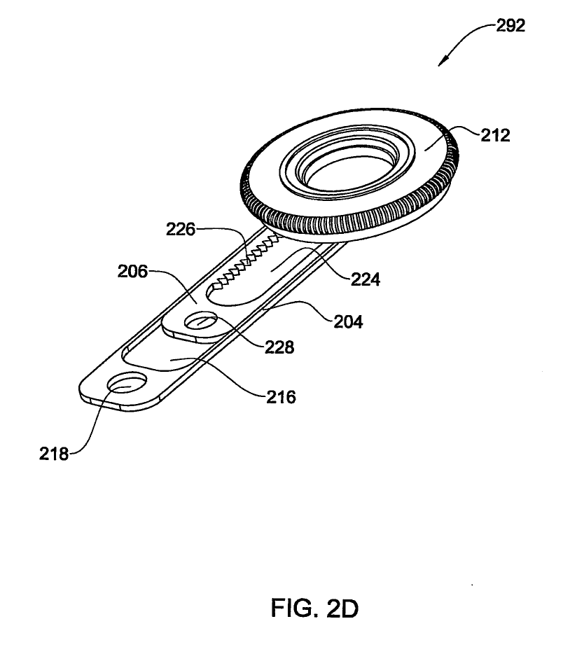

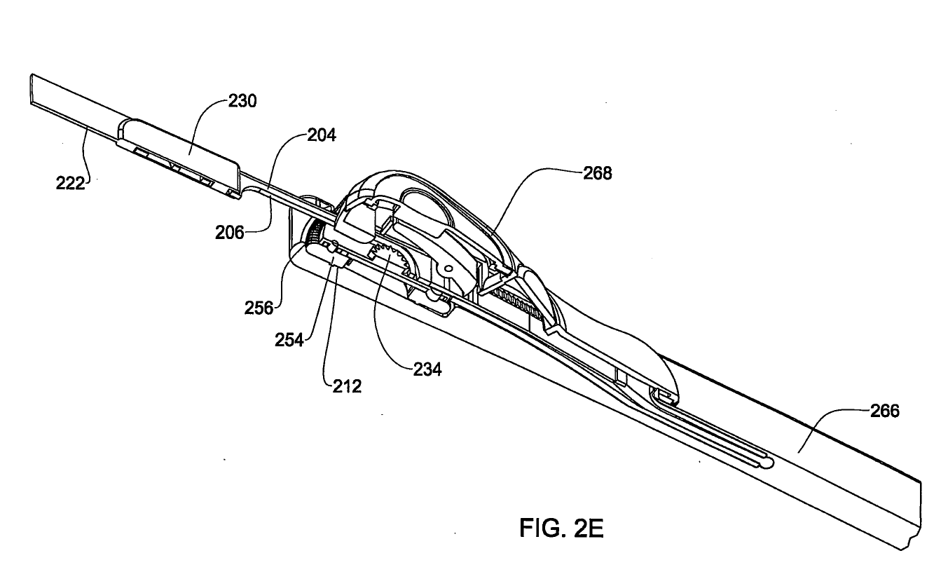

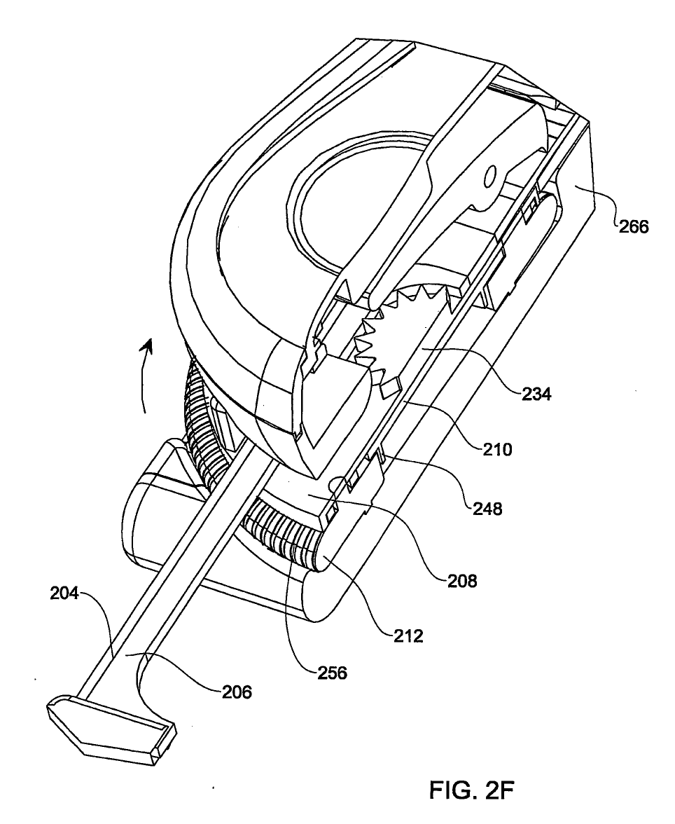

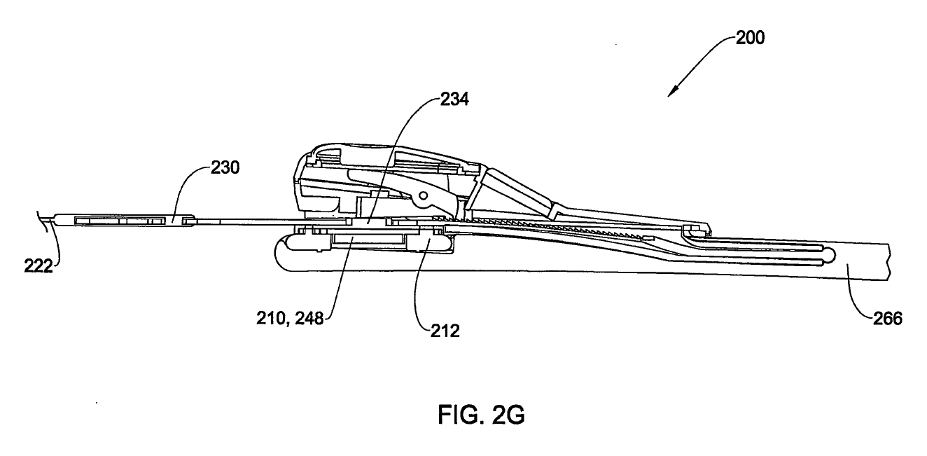

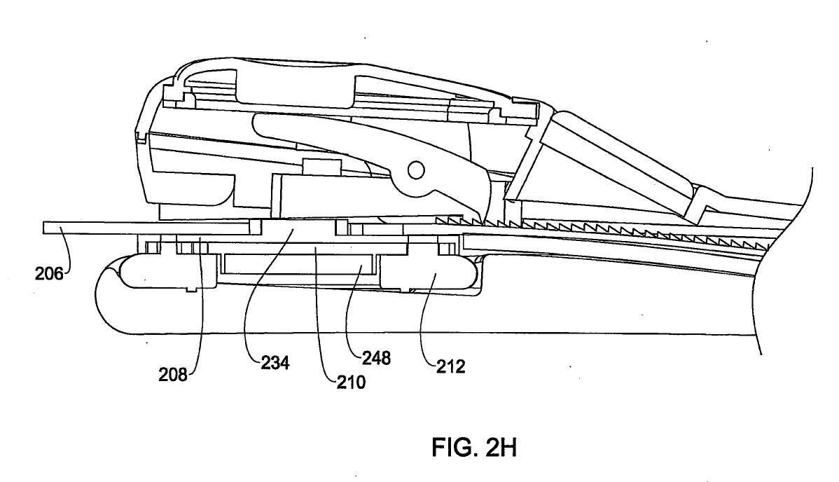

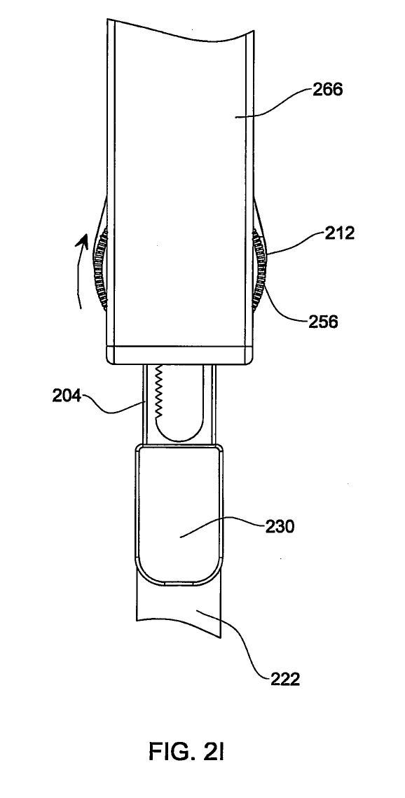

Turning attention to FIGS. 2A to 2I, there is illustrated an example of a weight-measuring device generally designated 200 which has an integral balancing mechanism 202 (FIGS. 2B and 2D), thus removing the need for a strap fastener 136 (shown in connection with the previous embodiment) or similar external balancing mechanism.

Focusing first on FIGS. 2B-2D, the balancing mechanism 202 comprises an outer strap 204, an inner strap 206 slidingly disposed inside the outer strap 204, a rotary sprocket wheel 208 mounted on the inner strap, a rotary spring and lock 210 mounted in the sprocket wheel 208, and a rotary wheel 212 engaging the rotary spring and lock 210.

Notably, the only differences between the weight-measuring device 100 of the previous embodiment and the weight-measuring device 200 of the present embodiment is that the plastic portion 112 of the weighing strap 102 has been replaced by the outer strap 204 and an inner strap 206, and there has been the addition of elements related to the balancing mechanism 202, namely four elements, being the rotary sprocket wheel 208, a rotary spring and lock 210, a rotary wheel 212 and a sleeve element 230 (FIG. 2A, to be further described hereinafter).

The outer strap 204 comprises a first end 214, a large slot 216, a first coupling aperture 218, and a second end 220. The first end 214 engages the elastic portion (not shown) of the weighing strap (not shown) in the same manner as the previous embodiment. The large slot 216 is designed to fixedly receive the inner strap 206. The aperture 218 is to allow the outer strap 204 to be coupled to another object, in the current example to a first strap 222 (FIG. 2A).

The inner strap 206 comprises a longitudinally oriented slot 224 having a row of teeth 226 along one of the longitudinal edges thereof, and a second coupling aperture 228. The aperture 228 allows the inner strap 206 to be coupled to a sleeve element 230, seen for example in FIGS. 2A and 2E. The sleeve element slides over the outer strap 204 and is present to prevent objects coming between the inner strap 206 and the outer strap 204.

The rotary sprocket wheel 208 (FIG. 2C) comprises a floor 232, a pinion gear 234 integrally formed in the floor 232 having teeth adapted for engagement with the row of teeth 206 of the inner strap 226, and an upwardly extending lip 236 having a serrated inner edge 238. At the assembled position the floor 232 of the rotary sprocket wheel 208 is flush with the corresponding surfaces of the inner and outer straps 206 and 204, respectively.

The rotary spring and lock 210 is adapted to sit inside the lip 236 of the rotary sprocket wheel 208 and comprises (FIG. 2B) a bottom portion 240, a top portion 242, a curved slot 244, a hook shaped slot 246, an upper annular protrusion 248, a side rim 250, and a side protrusion 252.

The rotary wheel 212 comprises a top surface 254, a gripping rim 256, a central aperture 257 adapted to receive the annular protrusion 248 of the rotary spring and lock 210. The rotary wheel 212 is further formed with a bottom surface 258, a first cylindrical protrusion 264 adapted to be received into the curved slot 244 of the rotary spring and lock 210, and a second cylindrical protrusion 262 adapted to be accommodated within the hook shaped slot 246 of the rotary spring and lock 210.

In FIGS. 2E-2H internal views of the assembled mechanism are shown. As can be seen the top surface 254 of the rotary wheel 212 is partially embedded within a second strap 266, to which the weight-measuring device 200 is attached, but remains capable of rotational movement within the second strap 266. The gripping rim 256 has a non-smooth surface and protrudes outwardly from the sides of the second strap 266, as seen best in FIG. 2I.

In the assembled position the rotary wheel 212 is engaged to the rotary spring and lock 210 via the following connection points: the central aperture 256 engages the annular protrusion 248, the first cylindrical protrusion 264 is inserted into the curved slot 244, and the second cylindrical protrusion 262 is inserted into the hook shaped slot 246; the rotary spring and lock 210 sits inside the rotary sprocket wheel 208 and rotates therewith when the side protrusion 252 engages the serrated inner edge 238. Notably this only occurs when the rotary wheel 212 is rotated in one direction. The rotary sprocket wheel 208 is mounted in the inner strap 206 via the pinion gear 234 which engages the row of teeth 226 thereof; rotation of the pinion gear 234 causes the teeth thereof to engage with the row of teeth 226 of the inner strap 206.

### In Operation:

A user may shorten the distance between the first strap 222 and the second strap 266 by rotating the rotary wheel 212 in a counter-clockwise direction with his fingers. The rotation of the rotary wheel 212 moves the second cylindrical protrusion 262 into the end portion of the hook shaped slot 246, expanding the hook shaped slot and thereby causing the side protrusion 252 to engage the serrated inner edge 238 of the rotary sprocket wheel 208, which is consequently rotated. Thus the pinion gear 234 engages the inner strap 206 causing the first strap 222 and the second strap 266 to be contracted together. Thus, the length of the straps may be adjusted and balanced.

Additionally, the second cylindrical protrusion 262 remains in the end portion of the hook shaped slot 246 causing the first strap 222 and the second strap 266 to be locked in the adjusted position.

Notably if the rotary wheel 212 is rotated in a clockwise direction, the first cylindrical protrusion 264 contacts one of the edges of the curved slot 244 of the rotary spring and lock 210, and the second cylindrical protrusion 262 is removed from the end portion of the hook shaped slot 246, causing the rotary spring and lock 210 to disengage from rotary sprocket wheel 208, and consequentially the first strap 222 disengages from the second strap 266, thus facilitating the proper conditions for weight measurement. It should also be noted that no other components rotate, in this case, as the side protrusion 252 does not engage the serrated inner edge 238 of the rotary sprocket wheel 208.

As in the previous embodiment the weight-measuring device 200 may measure the force magnitude applied thereto by a user depressing an identical depressible button 268. The only difference being in relation to the balancing mechanism 202 which, in unlocked position, allows the inner strap 204 and outer strap 206 to move, facilitating measurement of the force magnitude applied to the weight-measuring device 200.

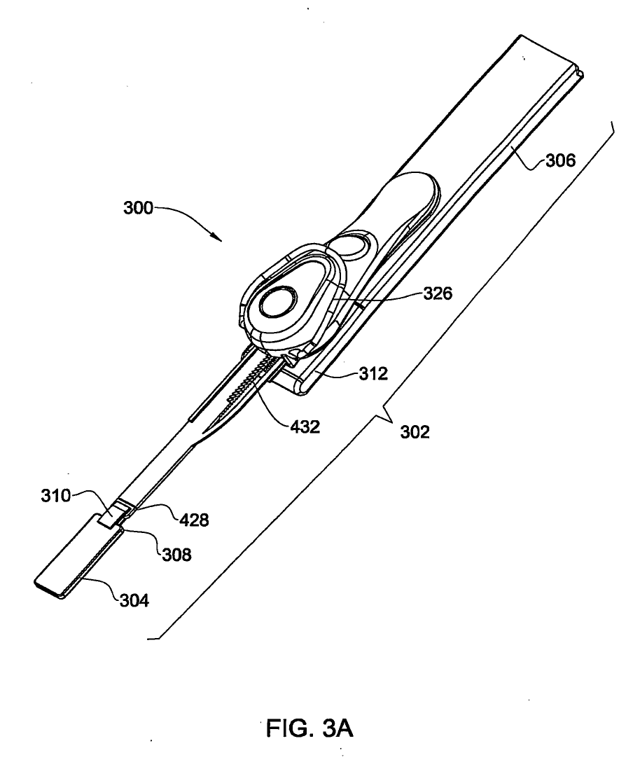

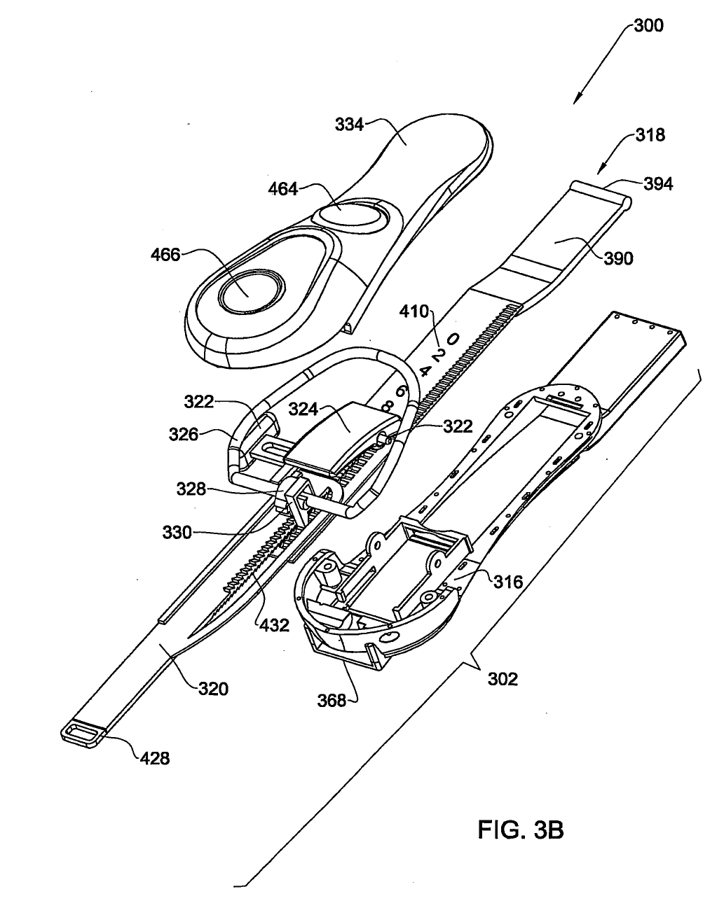

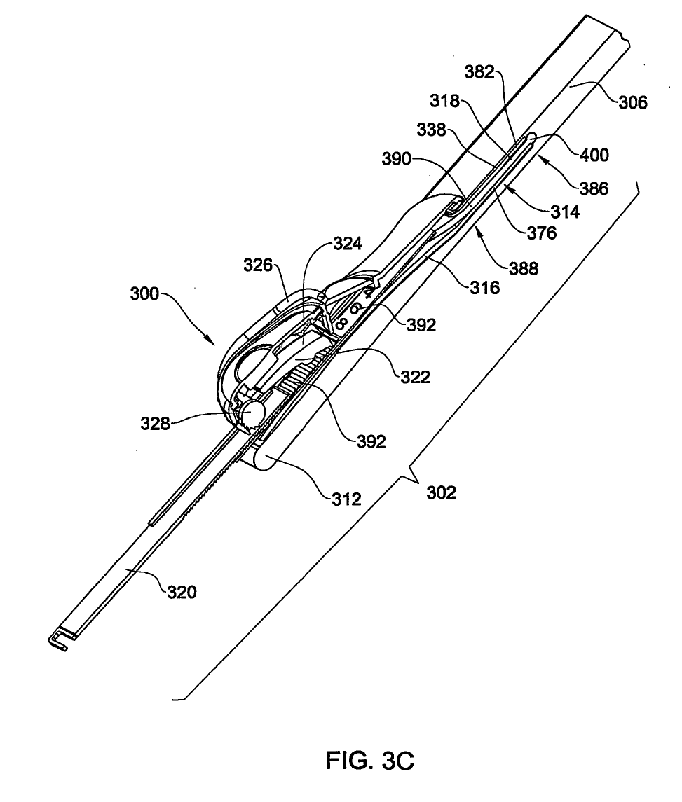

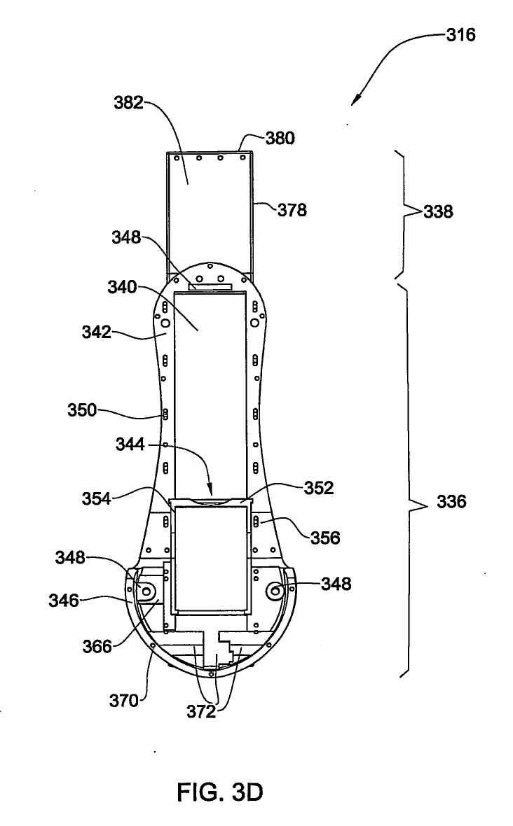

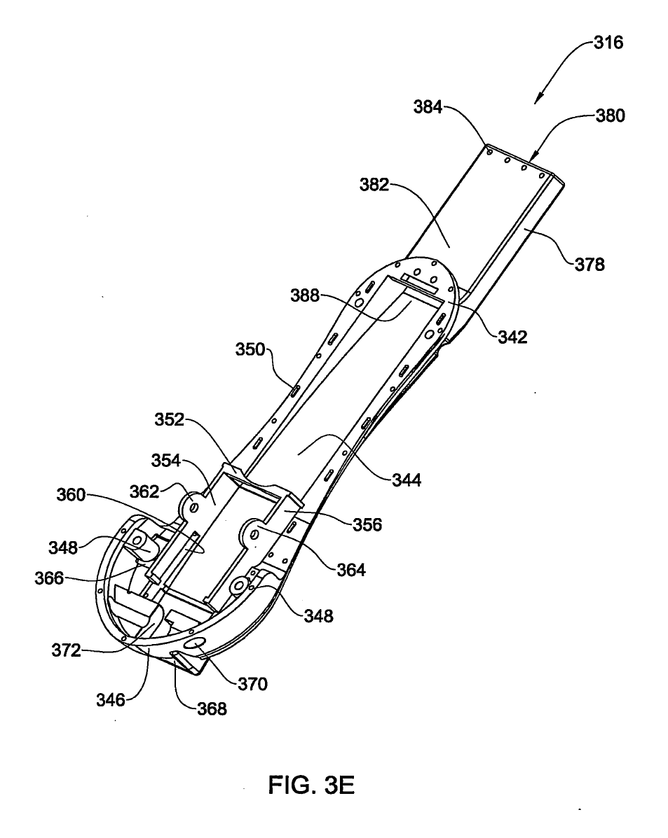

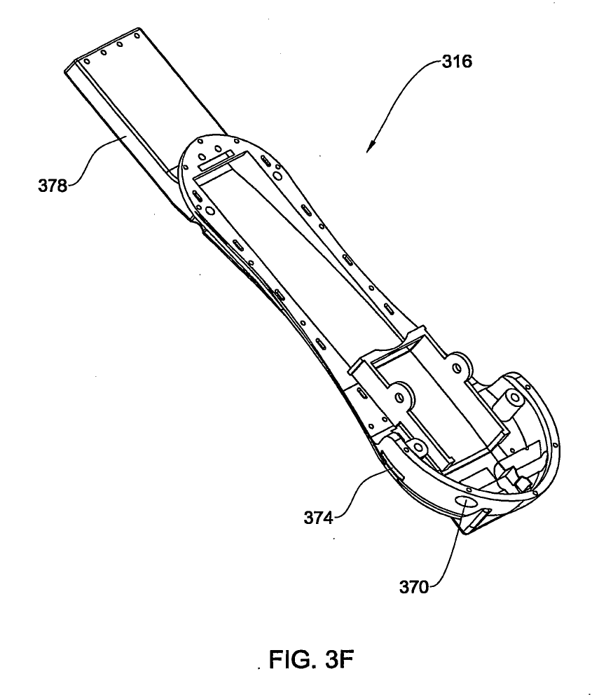

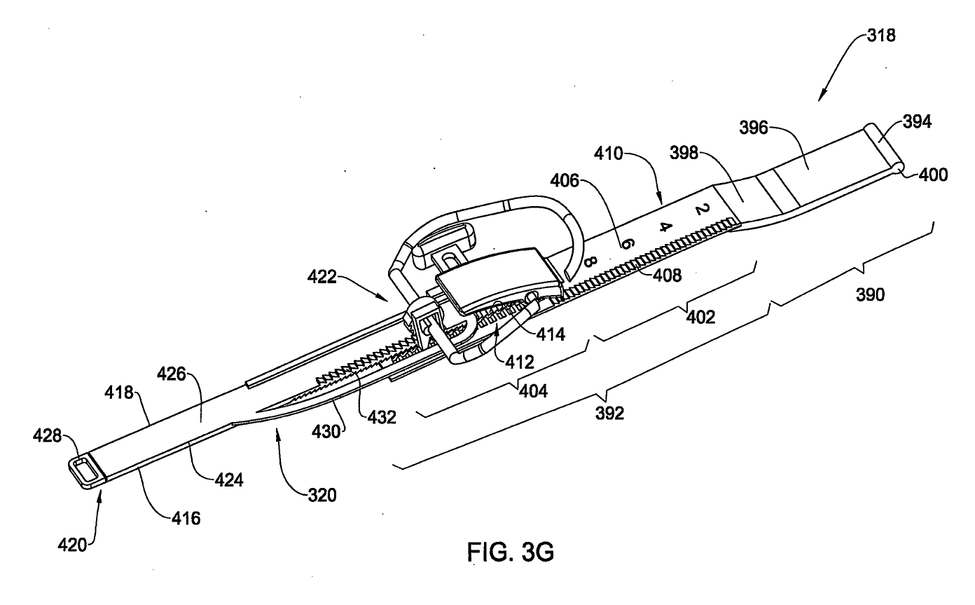

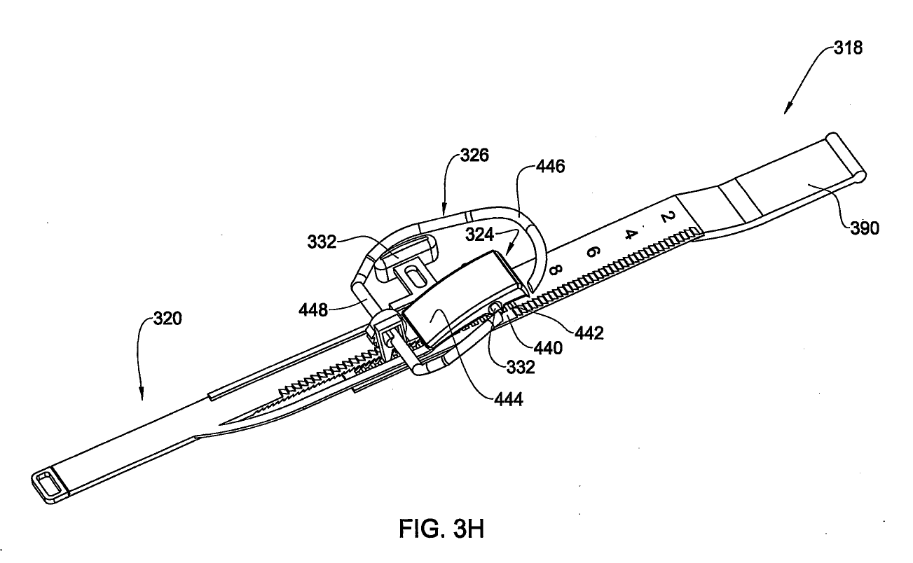

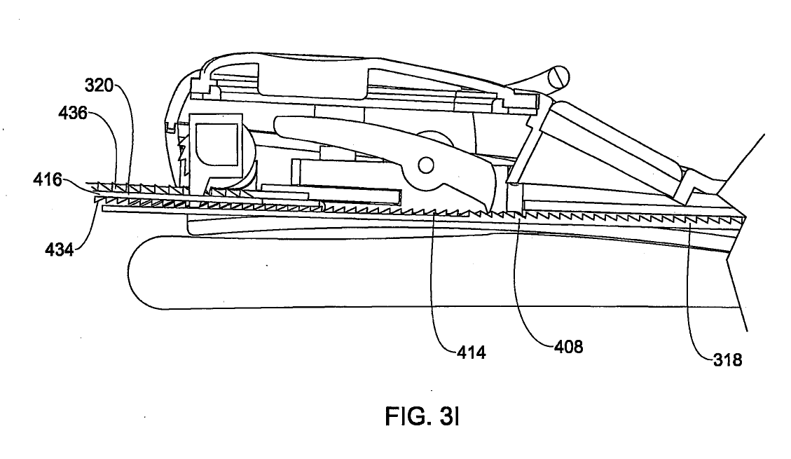

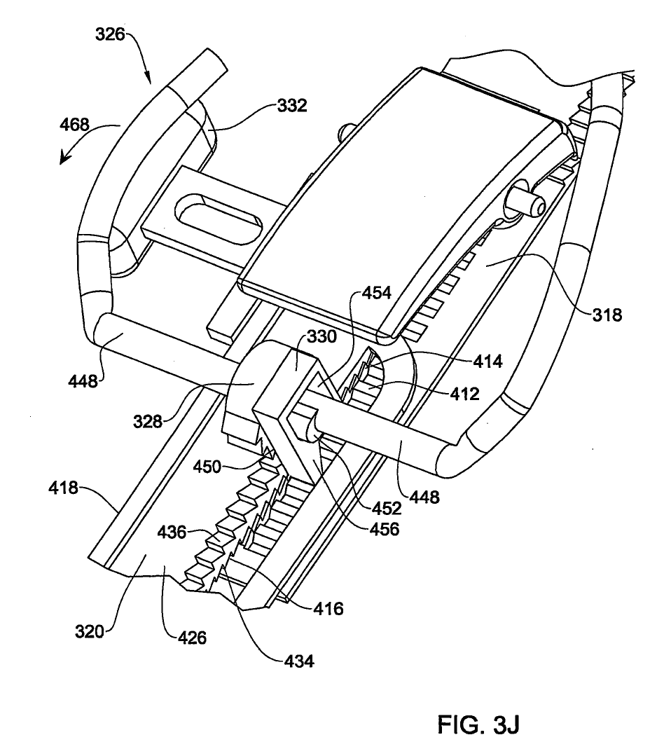

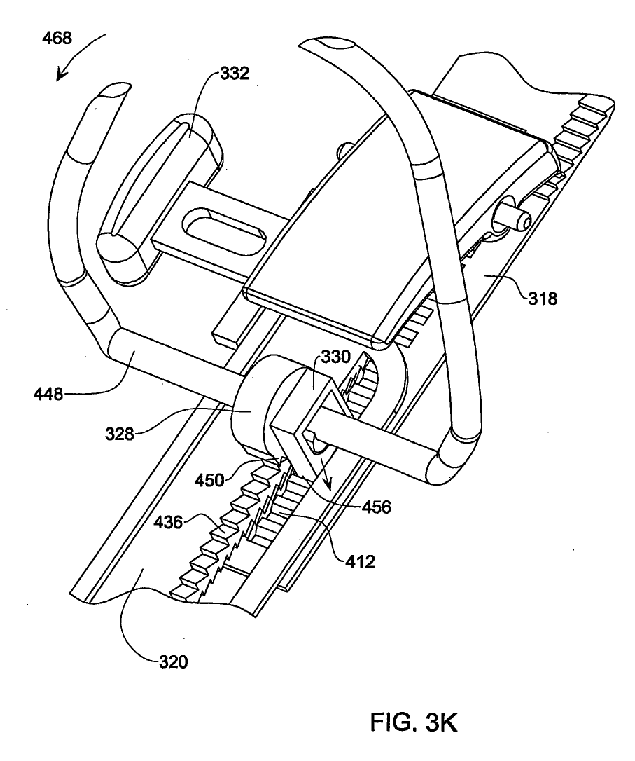

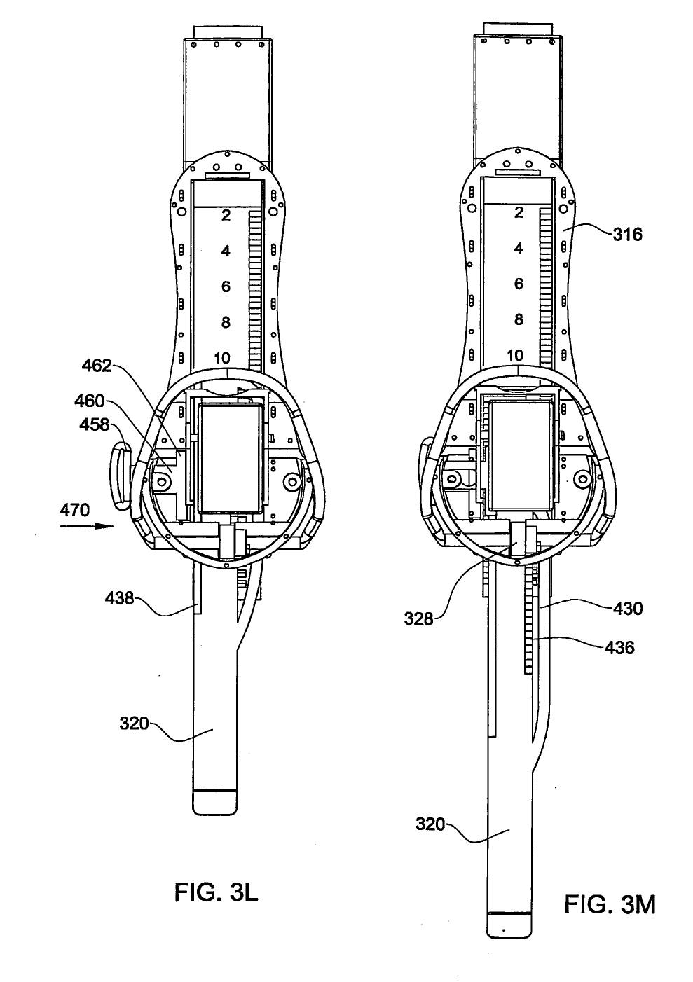

Referring now to FIGS. 3A to 3M, a further example of the weight measuring device 300 is illustrated. It should be noted that the weight measuring device 300 is similar to the previous example described, in that it is able to be incorporated into a shoulder strap assembly of a backpack (not shown) and comprises a force resistance element in the form of an elastic portion 390 connected to the shoulder strap assembly and adapted to measure the weight load thereof, and further comprises an integral balancing mechanism for lengthening and shortening the strap assembly.

Turning attention first to FIGS. 3A to 3C, a shoulder strap assembly 302 is seen with a weight measuring device 300 incorporated therein.

The shoulder strap assembly 302 comprises a lower strap 304 and an upper strap 306. The lower strap 304 extends between two ends, one end of which is attached to a lower portion of a backpack (not shown) and a second end 308 adapted to engage the weight measuring device 300 via a connecting strap portion 310 attached to the second end 308. The upper strap 306 has two ends, one end of which is attached to an upper portion of the backpack (not shown) and a second end 312 adapted to engage the weight measuring device 300 via a cavity 314 (FIG. 3C) formed in the upper strap 306. The cavity 314 may be part of the original manufacture of the backpack or a normal strap may be modified to form the cavity 314.

The weight measuring device 300 comprises a bottom housing 316 sown to the upper strap 306 and partially disposed within the cavity 314, a weighing strap 318 partially disposed within the bottom housing 316 and the cavity 314, a balancing strap 320 partially disposed within the bottom housing 316 and engaging the lower strap 304 and the weighing strap 318, a pin 322 mounted on the bottom housing 316, a ratchet mechanism 324 in the form of a pawl which is pivotally mounted on the pin 322, a D-shaped strap shortening lever 326 pivotally mounted on the bottom housing 316, a sprocket wheel 328 mounted on the lever 326 and adapted to engage the balancing strap 320, a sprocket lock 330 mounted on the lever 326 and rigidly connected to the sprocket wheel 328 and adapted to engage the weighing strap 318 through an aperture 432 formed in the balancing strap 320, a strap lengthening button 332 (FIG. 3B) projecting into and secured to the bottom housing 316 and adapted to engage the balancing strap 320, and a top housing 334 snappingly attachable to the bottom housing 316 and fitted with a button 466 adapted to engage the pawl 324.

The weight measuring device 300 will now be described in more detail.

Referring now also to FIGS. 3D-3F, the bottom housing 316 comprises a housing portion 336, and a sleeve portion 338.

The housing portion 336 comprises a floor 340, a rim 342 extending along a peripheral portion of the floor 340, a chamber 344 disposed in a central portion of the floor 340, and a C-shaped lip 346 extending from a peripheral portion of the floor 340.

The rim 342 is formed with sockets 348 and sowing apertures 350. The socket 348 are adapted to receive projections (not shown) formed on the inside of the top housing 334 for connection thereof to the bottom housing 316. The sowing apertures 350 are used for insertion of thread therethrough to allow sowing of the bottom housing 316 to the upper strap 306.

The chamber 344 comprises a transversely oriented wall 352, a first longitudinally oriented wall 354 extending from one corner of the transversely oriented wall 352, and a second longitudinally oriented wall 356 extending from the other corner of the transversely oriented wall 352, each of which projecting from the floor 340. It should be mentioned that the first and second longitudinal walls, respectively numbered 354 and 356 are spaced sufficiently to accommodate at least a portion of the weighing strap 318, balancing strap 320 and pawl 324 therebetween. The transverse wall 352 has a first transverse slot 358 formed therein (FIG. 3E), adapted for slidable insertion of a portion of the weighing strap 318 therethrough. The first longitudinal wall 354 has a rectangular cut out 360 (FIG. 3E) formed therein which is adapted for slidable insertion of a portion of the strap lengthening button 332 therethrough, and an O-shaped flange 362 formed thereon which is adapted for receiving the pin 322. The second longitudinal wall 356 has an O-shaped flange 364 formed thereon which is adapted for receiving the pin 322.

It should be noted that the C-shaped lip 346 is formed integral with two sockets 348 mentioned above, one of which notably having a recess 366 thereunder and hence not extending to the floor 340 for which purpose will be described hereinafter. Additionally, the C-shaped lip 346 comprises a second transverse slot 368 (best seen in FIG. 3B) formed at a central portion of the lip 346, a pair of concentric apertures 370 formed therein and disposed between the transverse slot 368 and connecting sockets 348, a support seat 372 to be described hereinafter, and a longitudinal slot 374 formed adjacent to the recess 366.

The sleeve portion 338 comprises a floor portion 376 (FIG. 3C) extending to the floor 340 of the bottom housing 316, opposing longitudinally oriented side wall portions 378 extending upwardly from the floor portion 376, an end wall portion 380 extending upwardly from the floor portion 376 and extending between the side wall portions 378, and a lid portion 382 attachably detachable to the side walls 378 and end wall portion 380 (in this case via fasteners 384) and which engages the rim 342. The end wall portion 380 has a third transverse slot 386 (FIG. 3C) formed therein. There is also a fourth transverse slot 388 formed by the connecting areas of the floor portion 376, side wall portions 378 and lid portion 382.

Turning attention now to FIGS. 3C, 3G and 3I, the weighing strap 318 comprises a force resistance element 390 in the form of an elastic portion, and a plastic portion 392.

The elastic portion 390 comprises a top end 394, an intermediate portion 396 and a bottom end 398. The top end 394 comprises an bulging portion 400 which, when the weight measuring device 300 is assembled and consequently the weighing strap 318 is inserted through the sleeve portion 338, is disposed on the outside of the third transverse slot 386 (FIG. 3C), and is thicker than the slot 386 to prevent traversing therethrough. The intermediate portion 396 is thinner than the bulging portion 400, and when the elastic portion 390 is inserted through the sleeve 338, the intermediate portion 396 extends through the third and fourth transverse slots, respectively numbered 386 and 388, without being clasped thereby for reasons which will become apparent hereinafter.

The plastic portion 392 comprises a top-half section 402 integrally formed with the bottom end 398 of the elastic portion 390 (integrated through a manufacturing process or articulated thereafter), and a bottom-half section 404. Additionally, each of the sections of the plastic portion 392 identified above have a lower face (not shown), and an upper face 406. The upper face 406 of the top-half section 402 comprises a narrow column 408 of uni-directional slanted teeth disposed along one side thereof and a series of ascending numbers 410, for indication of weight measurement, adjacent to the teeth 408. The upper face 406 of the bottom-half section 404 comprises a narrow column of spaced square teeth 412 (best seen in FIG. 3J) disposed along one side thereof and a wide column of uni-directional slanted teeth 414 adjacent to the square teeth 412.

It should be noted that when the weight measuring device 300 is being assembled, the weighing strap 318 is inserted into the bottom housing 316 via the first, second, third and fourth transverse slots, respectively numbered 358, 368, 386 and 388, and is anchored by the bulging portion 400 to the outside of the third transverse slot 386 (FIG. 3C) which, notably, is the only transverse slot that impedes the longitudinal motion of the weighing strap 318. After insertion of the weighing strap 318 into the bottom housing 316, the sleeve portion 338 is inserted into the cavity 314 and the bottom housing 316 is sown to the upper strap 306 via the sowing apertures 350.

As seen in FIGS. 3A, 3G and 3J, the balancing strap 320 comprises a first edge 416, a second edge 418, a lower end 420, an upper end 422, a bottom face 424 and a top face 426. The lower end 420 has a rectangular coupling slit 428, adapted for insertion of the connecting strap portion 310 therethrough. The connecting strap portion 310 is thus threaded through the rectangular slit and fastened to the lower strap 304, in this example, by Velcro™ (not shown). It should be noted, however, that any fastener may be used to connect the connecting strap portion 310 to the lower strap 304.

The upper end 422 comprises a ream element 430 in the form of an integral D-shaped elastic portion, extending along the first edge 416. The D-shaped portion 430 comprises a D-shaped slot 432 formed therein. The bottom face 424 comprises a wide column of unidirectional slanted teeth 434, adapted for single-directional locking engagement with the wide column of slanted teeth 414 on the upper face 406 of the plastic portion 392 of the weighing strap 318 (best seen in FIG. 3I). The top face 426 comprises a narrow column of slanted teeth 436 formed along the first edge 416 of the balancing strap 320, and a push bar 438 formed on and extending along the second edge 418 of the balancing strap 320. During assembly, the balancing strap 320 is inserted into the second transverse slot 368 of the bottom housing 316 and is disposed over and engages the weighing strap 318.

Referring now to FIG. 3H, the pawl 324 is disposed within the chamber 344 (FIGS. 3D-3F) and comprises a pivot hole 440 adapted for the insertion of the pin 322, a pointed distal projection 442 adapted for engagement with the teeth of the narrow column of uni-directional slanted teeth 436 on the plastic portion 392, and a button portion 444 disposed at the end of the pawl 324 not comprising the distal projection 442. During assembly, the pin 322 is inserted through the O-shaped flanges 362 and 364 (FIG. 3E) and the pivot hole 440 in the pawl 324 to allow rotation of the pawl 324.

The D-shaped strap shortening lever 326 is pivotally mounted to the bottom housing 316 and comprises a curved gripping portion 446 and a straight portion 448. Referring now also to FIGS. 3D-3F, during assembly the straight portion 448 is inserted into the bottom housing 316 via the pair of concentric apertures 370 formed in the lip 374 thereof and the curved portion 446 is attached to the straight portion 448.

Reverting now to FIG. 3J, the sprocket wheel 328 is mounted on the lever 326 via a central aperture (not shown) formed therein, and comprises teeth 450 which are adapted for engaging the narrow column of slanted teeth 436 on the balancing strap 320 and pressing the balancing strap 320 against the weighing strap 318 for locking engagement, and a moon-shaped lateral projection 452 for receiving the straight portion 448 of the lever 326.

The sprocket lock 330 comprises a rectangular slot 454 and a square-shaped tooth projection 456. The rectangular slot 454 is adapted for tight fit insertion of the moon-shaped projection 452 when the straight portion 448 of lever 326 is received therein. The square-shaped tooth projection 456 is adapted for engagement into the narrow column of square teeth 412, when rotated to an appropriate angle (see FIG. 3K). The aforementioned tight fit facilitates rotation of both the sprocket wheel 328 and the sprocket lock 330 when the lever 326 is rotated. Additionally, referring briefly to FIG. 3D, it should be noted that the support seat 372 of the bottom housing 316 has appropriately shaped recesses for the lever 326, sprocket wheel 328 and sprocket lock 330 to rest thereon, while still allowing rotation thereof. Furthermore, the square-shaped tooth projection 456 at all times projects through the D-shaped slot 432 arresting longitudinal motion of the balancing strap 320 in either direction.

Turning attention to FIG. 3L, the strap lengthening button 332 comprises a button portion 458, a neck portion 460 attachable to the button portion 458 and a base portion 462 extending from the neck portion 460. Referring now also to FIGS. 3D-3F, the neck portion 460 is adapted for slideable motion within the longitudinal slot 374 and the recess 366 in the bottom housing 316. During assembly, the neck portion 460 is inserted through the longitudinal slot 374 such that the base portion 462 is in contact with the push bar 438, and the button portion 458 is subsequently attached to the neck portion 460. It should be noted that the button portion 458 and base portion 462 are larger than the longitudinal slot 374 to prevent the lengthening button 332 from falling thereout.

Reverting to FIG. 3B, the top housing 334, which is adapted to snappingly connect to the bottom housing 316 and cover all of the components disposed therebetween, comprises a display window 464, a button 466 and internal projections (not seen). The display window 464 is in the form of a magnifying lens disposed above the series of ascending numbers 410 on the weighing strap 318, enabling them to be easily read therethrough. The button 466 is disposed above and engages the button portion 444 of the pawl 324.

As described hereinbefore, the top housing 334 further comprises internal projections (not seen) formed therein for snapping connection to the bottom housing 316 via the sockets 348 formed therein.

As mentioned above, the weight measuring device 300 also allows balance control via lengthening and shortening of the shoulder strap assembly 302 using elements which constitute an integral balancing mechanism. In this example the balancing mechanism is comprised of all of the elements, excluding the top housing 334, without which the balancing would not be possible. It should be noted that as the example describes an integral balancing mechanism, some of the elements in this example have a dual function, therefore the specific elements which constitute the “balancing mechanism” are not be highlighted as such to avoid confusion, because in one state an element may operate to provide a weight determination function and in another the same element may provide the balancing function. Nonetheless, the description of the balancing operation will clarify which components provide a weighing function and which provide a balancing function.

In operation, the weight measuring device 300 provides a user the ability to determine the weight load, lengthen and shorten the shoulder strap assembly 302 to which it is incorporated and thus balance inter-shoulder weight load.

Regarding weight load determination, the weight measuring device 300 can be described as having an unstretched state and a stretched state. As seen in FIG. 3G the pawl 324 is normally biased such that the distal projection 444 engages the teeth of the narrow column of uni-directional slanted teeth 408 of the plastic portion 392 in a so called “locking action”. This normally biased position of the pawl 324 is referred to as the “unstretched state”.

As the elastic portion 390 of the weighing strap 318 is anchored at the top end 394, and the aforementioned locking action arrests stretching motion of the bottom end 398 of the elastic portion 390 via the plastic portion 392, the locking action essentially holds the elastic portion 390 static. It is noted that the slanted teeth 408 to which the pawl 324 is connected are uni-directional, therefore the locking action only prevents stretching motion of the elastic portion 390. Thus when there is no stretching force on the elastic portion, the elasticity of the elastic portion 390 pulls the weighing strap 318 back to an unstretched state even during the locking action.

The unstretched state allows extended calibration lifespan of the force resistance element by reducing the time that the elastic portion 390 is stretched. To determine the weight load of the shoulder strap assembly 302, the assembly 302 is carried such that a stretching force is applied to the weight measuring device 300 (not shown), for example by wearing the backpack (not shown) to which the assembly 302 is connected. A user must then push the button 316 which impacts the button portion 444 of the pawl 324 rotating it and disengaging the distal projection 442 from the slanted teeth 436 on the plastic portion 392 (FIG. 3H). The elastic portion 390 is thus stretched by the stretching force applied to it via the lower strap 304 and balancing strap 320 on one side, and the upper strap 306 to which it is anchored via the sleeve 338 on the other, which constitutes the so-called stretched state (FIG. 3H).

At the stretched state the user reads the appropriate number 410 which appears through the display window 464 to gauge the weight load on the shoulder strap assembly 302. The user then releases the button 316 and the pawl 324 returns to it's normally biased position. When the stretching force is removed from the shoulder strap assembly 302, for example by the user putting the backpack (not seen) on the floor (not seen), the elastic properties of the elastic portion 390 return the weight measuring device 300 to the so-called unstretched state (FIG. 3G) as described above.

Referring to FIG. 3J, to shorten the shoulder strap assembly 302, a user grasps the lever 326 in its normal position (as shown in FIG. 3J, namely extending substantially parallel with the straps) and rotates the lever 326 in the direction of arrow 468.

Referring now to FIG. 3K, the rotation results in the sprocket wheel 328 and sprocket lock 330 rotating. The sprocket wheel teeth 450 consequently pushes the slanted teeth 436 on the balancing strap 320, which as a result slides over the plastic portion 392 of the weighing strap 318 and then locks thereto, thereby shortening the shoulder strap assembly 302. The user then returns the lever 326 to its normal position, and may repeat the lever rotation for a further shortening action. Notably, the return movement does not provide a return motion to the balancing strap 320 due to the uni-directional nature of the slanted teeth 436 on the top face 426 of the balancing strap 320, the slanted teeth 434 on the bottom face 424 of the balancing strap 320, and the slanted teeth 414 on the plastic portion 392 of the weighing strap 318. Additionally, rotation of the sprocket lock 330, causes the square-shaped tooth 456 to engage the square teeth 412 on the plastic portion 392, arresting the motion of the weighing strap 318. Furthermore the square tooth 456 functions as a mechanical stop if it contacts the periphery of the D-shaped slot 432, preventing the balancing strap 320 from entering too far into the bottom housing 316.

Referring to FIG. 3L, to lengthen the shoulder strap assembly 302, the user presses the button portion 458 of the strap lengthening button 332 in the direction of arrow 470. The base portion 462 pushes the push bar 438 sideways and displaces the balancing strap 320 relative to the remainder of the components of the weight measuring device 300, as shown in FIG. 3M.

Referring now to FIG. 3M, in this position the narrow column of slanted teeth 436 on the balancing strap 320 is not disposed directly below the teeth 450 of the sprocket wheel 328 as shown in previous drawings and the D-shaped elastic portion 430 is compressed within the second transverse slot 368 (FIG. 3B). If a stretching force is then applied to the weight measuring device 300 the balancing strap 320, which is no longer pressed against the weighing strap 318 for locking engagement, slides out of the bottom housing 316.

Similar to the shortening procedure above, the square tooth 456 functions as a mechanical stop if it contacts the periphery of the D-shaped slot 432, preventing the balancing strap 320 from exiting the bottom housing 316. After the button 458 is released the D-shaped elastic portion 430 spontaneously reverts to it's normal shape and pushes the balancing strap 320 back to the position shown in FIG. 3L. In this position the sprocket wheel 328 re-contacts the slanted teeth 436 on the balancing strap 320 which re-engages the weighing strap in a locking fashion.

Those skilled in the art to which this invention pertains will readily appreciate that numerous changes, variations and modifications can be made without departing from the scope of the invention mutatis mutandis.

For example, the device according to the present invention is suitable also as a ‘stand alone’ article, namely suitable for separate accessory article detachably connectable to any device.

1. A weight-measuring device adapted to be attached between two objects to measure the force magnitude therebetween, comprising a force resistance element, and a weight indicator providing an indication of the force magnitude applied thereto, the device adapted to be brought to a stretched state when the force resistance element is altered by the application of forces by the two objects, and unstretched state when the force resistance element is not altered by the application of forces by the two objects; and a visual indication corresponding with the force applied.

2. The weight-measuring device of claim 1, further comprising a balancing mechanism which is adapted to change the force magnitude between the two objects.

3. The weight-measuring device of claim 2, wherein the balancing mechanism is adapted to lengthen and/or shorten the distance between the two objects, thereby changing the force magnitude therebetween.

4. The weight-measuring device of claim 2, wherein the balancing mechanism is an integral part of the weight-measuring device.

5. The weight-measuring device of claim 1, wherein said force resistance element is a strap made of an elastic material.

6. The weight-measuring device of claim 5, wherein said elastic material is made of natural rubber.

7. The weight-measuring device of claim 1, wherein said weight indicator comprises a numerical scale associated with said force resistance element.

8. The weight-measuring device of claim 1, wherein said weight measuring device further comprises a display window for viewing the weight indicator.

9. The weight-measuring device of claim 8, wherein the display window is made of magnifying glass.

10. A weight measuring device according to claim 1, wherein the two objects between which the weight-measuring device is attached are two portions of a shoulder strap assembly of a harness.

11. A weight measuring device according to claim 1 detachably connectable to any article for weight measuring.

12. A weight measuring device according to claim 10, wherein the harness is part of a backpack or flying bag or suitcase or a parachute apparatus.

13. A harness comprising a pair of shoulder strap assemblies, with each shoulder strap assembly including a weight-measuring device being attached between two portions thereof, the weight-measuring device comprising a force resistance element altered by the application of force thereto, and a weight indicator providing an indication of the force magnitude applied thereto, the weight-measuring device being adapted to be brought to a stretched state and to a unstretched state, so that when the weight-measuring device is in the stretched state the force resistance element is altered by the application of forces by the two portions of the shoulder strap assembly, and when the weight-measuring device is in the unstretched state the force resistance element is not altered by the application of forces by the two portions of the shoulder strap assembly, the unstretched state thereby improving the calibration lifespan of the force resistance element.

14. The harness of claim 13, further comprising a balancing mechanism which is adapted to change the force magnitude between the two shoulder straps.

15. The harness of claim 14, wherein said balancing mechanism is adapted to lengthen and/or shorten the distance between the two shoulder straps thereby changing the force magnitude therebetween.

16. The harness of, claim 14, wherein said balancing mechanism is an integral part of the weight-measuring device.

17. The harness of claim 13, wherein said force resistance element is a strap made of an elastic material.

18. The harness of claim 17, wherein said elastic material is made of natural rubber.

19. The harness of claim 13, wherein said weight indicator comprises a numerical scale associated with said force resistance element.

20. The harness of claim 13, wherein said weight measuring device further comprises a display window for viewing the weight indicator.

21. The harness of claim 20, wherein the display window is made of magnifying glass.

22. The harness according to claim 13, wherein said harness is part of a backpack or a parachute apparatus.

23. The harness of claim 13, wherein the each of the shoulder strap assemblies includes two fasteners configured for detaching the corresponding weight-measuring device.
